(19) United States
(12) Patent Application Publication
(10) Pub. No.: US 2004/0146676 A1
(43) Pub. Date: Jul. 29, 2004

(54) Flexible hose

(76) Inventor: Ayumu Ikemoto, Komaki-shi (JP)

Correspondence Address: Eugene Lieberstein, Esq., Anderson Kill & Olick, P.C., 1251 Avenue of the Americas, New York, NY, 10020, US

(21) Appl. No.: 10/718,751

(22) Filed: Nov. 21, 2003

(30) Foreign Application Priority Data
Nov. 20, 2002 (JP) 2002-336845

(51) Int. Cl. F16L 1/00

(52) U.S. Cl. 428/36.8

(57) ABSTRACT

The present invention is a flexible hose having a metal bellows tube 1 comprising a rubber layer 2 on the outer circumference of the metal bellows tube 1; and an exterior layer formed on the outer circumference of the rubber layer 2; wherein the metal bellows tube 1 has a corrugated bellows structure with a plurality of spaced apart rings 5 having peaks 6 and a plurality of channels 7 disposed between the rings which vary in width in a radial direction with the channels forming relatively wide valleys below the peaks. The rubber layer 2 is of a composition including at least a rubber of an acryl group and/or a rubber of an ethylene-propylene-diene group and with the rubber layer 2 being flowable at low temperature such that each channel in the metal bellows tube 1 is filled with rubber throughout each valley.

### TECHNICAL FIELD

The present invention relates to a flexible hose for use as a fuel hose, air hose, air conditioning hose, or a hose for a fuel cell powered vehicle or the like.

### BACKGROUND OF THE INVENTION

Recently, regulations relating to vaporization of a fuel gas used for a car have been made more rigorous. Since great reductions in the amount of vaporization of a fuel from a hose are required, various types of low permeability hoses corresponding to the vaporization requirement have been studied. Such a hose may include, for example, a tubular metallic hose having a bellows configuration (“metal bellows tube”) extending over at least part of the length of the hose. To further improve the durability and vibration absorbing property of a metal bellows tube hose, the prior art teaches forming a silicon rubber layer over the surface of metal bellows tube and adding an additional reinforcing layer. The silicon rubber layer is intended to absorb vibration and to prevent abrasion.

In the prior art of Japanese Patent Kokai No. H12-337572 a silicon rubber layer is formed on a metal bellows tube having a corrugated configuration. The silicon rubber layer connects the peaks of the metal bellows tube, but the valley formed between peaks is not filled with rubber. Therefore, by merely making contact with the peaks of the metal bellows tube, the hose has a low adhesive property between the metal bellows tube and the rubber layer allowing the contact faces of the metal bellows tube to shift relative to the rubber layer. Also, upon application of a high internal pressure within the hose, the peaks of the bellows tube widens in the width direction to deform the bellows which can result in reduced flexibility or elasticity and reduced durability.

More particularly, since the pitch of the metal bellows tube hose tends to be reduced it is important for the rubber layer surrounding the metal bellows tube hose to fill up valleys which form between the corrugations in the metal bellows tube with rubber. When silicon rubber is used for the rubber layer, as in the above prior art patent reference, poor adhesion also exists between the reinforcing layer and the silicon rubber layer causing shifting to occur between the contact faces of the rubber layer and the reinforcing layer, resulting in a low durability of the hose. It is difficult to apply an adhesive agent to the contact faces of the silicon rubber layer and the reinforcing layer since this would increase the number of process steps in the manufacturing operation and has other disadvantages from the point of view of its environmental effect and cost.

It is a primary object of the present invention to provide a flexible hose comprising a metal bellows tube having a rubber layer and an exterior layer with the rubber layer having a composition which will create excellent adhesion between the bellows tube and the rubber layer and between the rubber layer and the exterior layer.

### SUMMARY OF THE INVENTION

The present invention is a flexible hose comprising: a metal bellows tube having a first rubber layer on the outer circumference thereof; and a second layer formed on the outer circumference of the first rubber layer; wherein the metal bellows tube has a corrugated structure with a plurality of spaced apart rings having peaks and a plurality of channels disposed between the rings forming valleys therebetween which vary in width in a radial direction from the peaks and wherein the first rubber layer is composed of a rubber composition including at least a rubber of an acryl group and/or a rubber of an ethylene-propylene-diene group and with the rubber layer being flowable at low temperature such that each channel is filled with rubber at such low temperature substantially throughout the valley.

Applicant discovered that to achieve excellent adhesive properties between the layers of a flexible hose having a metal bellows tube and to provide excellent durability, the layer adjacent the metal bellows tube should be of a composition comprising at least a rubber of an acryl group and/or a rubber of an ethylene-propylene-diene group and that the rubber composition should be flowable at low temperature so as to enable the rubber to sufficiently fill each channel in the metal bellows tube to the full depth of the valley between corrugations independent of a the width between peaks.

Using a rubber composition which contains at least either a rubber of an acryl group and/or a rubber of an ethylene-propylene-diene group (EPDM) which is flowable at low temperature to form the intermediate rubber layer results in filling up the channels between the rings in the bellows structure down into the valleys. As a result, the adhesive property between the metal bellows tube and the intermediate rubber layer is excellent and no shifting occurs between contact faces of both layers, resulting in improved hose durability. The metal bellows tube has a preferred bellows corrugated structure in which the plurality of rings are spaced apart to form channels with the width of each channel between the peaks of the rings being small but with each channel forming a large valley in the radial direction. Since the width of each channel formed between peaks is small, the durability, elasticity, flexibility of the hose is further improved.

Also, when a reinforcing layer is formed between an intermediate rubber layer and external layer, the durability of a hose is also improved.

Also, when a compound of a resorcinol group is used together with the above specific rubber to form the intermediate rubber layer, the adhesive property between the intermediate rubber layer and a metal bellows tube on its inner circumferential side and between the intermediate rubber layer and a reinforcing layer on its outer circumferential side is even further improved.

### BRIEF DESCRIPTION OF THE DRAWINGS

FIG. 1 is a side section showing a main portion of a flexible hose in accordance with the present invention.

FIG. 2 is an illustration for a whip test for assessing durability.

### DETAILED DESCRIPTION OF THE INVENTION

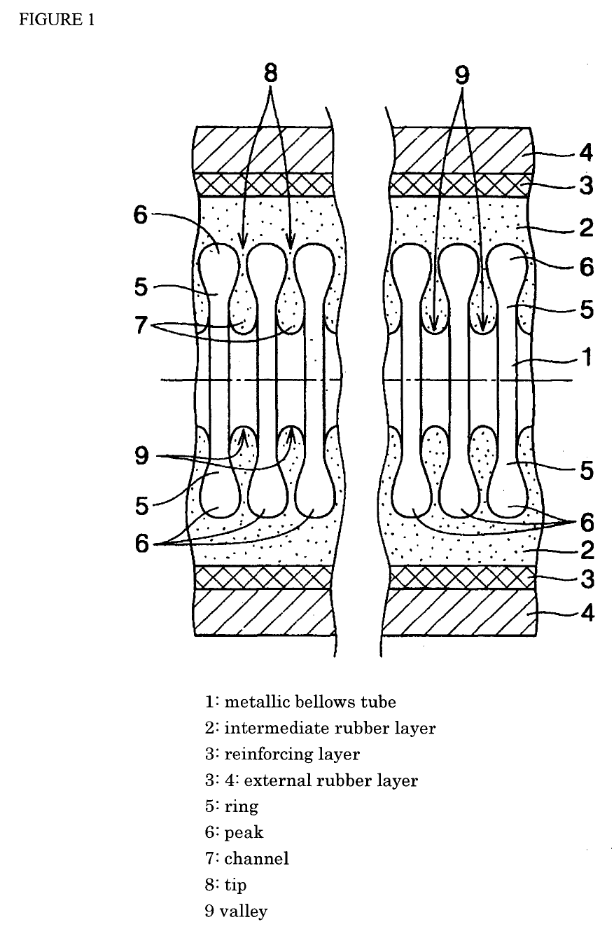

A flexible hose of the present invention as shown in FIG. 1 includes, for example, a intermediate rubber layer 2 as defined hereinafter formed at the outer circumferential face of the metal bellows tube 1, reinforcing layer 3 formed at the outer circumferential face of the layer 2 and an external layer 4 formed at the outer circumferential face of the layer 3.

The metal bellows tube 1 of the present invention is a corrugated structure having a plurality of rings 5 disposed at predetermined intervals with each ring 5 having a peak 6 located on the radially outside of each ring 5 and a channel 7 formed between each of the peaks 6 one after the other. This is not a spiral structure and the channels are not of spiral geometry. Instead, the metal bellows tube 1 of the present invention has a structure with separate and independent channels.

The structure of the metal bellows tube 1 is formed so that the width (pitch) of channel 7 formed between peaks 6 of each ring 5 is small leaving a narrow tip 8 in each channel 7 and a large valley 9. The composition of the intermediate rubber layer is flowable at low temperature to fill channel 7 as far down as valley 9, resulting in improved durability of the hose.

The width of tip 8 in each channel 7 is preferably between about 0.1 to about 1.0 mm and more preferably between about 0.2 to about 0.8 mm.

The metal bellows tube 1 of the present invention has a bellows structure extending over at least part of the length of the metal bellows tube but is not limited to one in which the bellows structure extends for the full length of the metal bellows tube.

The metal bellows tube 1 may be formed from a composition of, for example, iron, iron alloy (SUS and the like), aluminum, aluminum alloy and the like. Among them, SUS is preferred from the point of view of the flexibility and anticorrosion property.

The thickness of metal bellows tube 1 is usually between about 0.1 to about 1.5 mm and preferably between about 0.15 to about 1.0 mm.

The intermediate rubber layer 2, which is formed on the surface of the metal bellows tube 1, should be of a rubber composition containing at least a rubber of an acryl group and/or a rubber (EPDM) of an ethylene-propylene-diene group and should be flowable at low temperature.

In the present invention, the intermediate rubber layer composition which is flowable at low temperature is most preferably a rubber composition having a Mooney viscosity (MV) of between about 10 to about 55 M, preferably between about 15 to about 45 M, at around 100° C.

The rubber composition is comprised of an acryl group that preferably vulcanizes upon reaction with a peroxide. More preferably, the intermediate rubber layer comprises an alkene-acrylic ester co-polymer is comprised of mer units (α) or (β) of the formulae (I) or (II).

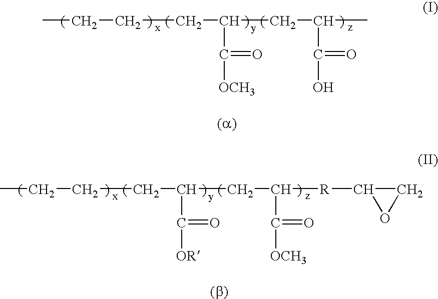

wherein, x=29.9˜74.9, preferably from 34.7˜69.7, y=25˜70, preferably 30˜65, z=0.1˜10, preferably 0.3˜7. R is hydrogen or ethyl group. R′ is alkyl group with carbon number 1˜18.

In the unit (α), a carboxyl group is a crosslinking group. Also, in the unit (β), an end epoxy group is a crosslinking group. An ethylene-acrylic ester copolymer having this structural unit (α) within its molecular structure includes, for example, VAMAC-G manufactured by du Pont and the like. Also, an ethylene-acrylic ester copolymer having this structural unit (β) within its molecular structure includes, for example, Denka ER manufactured by Denki Kagaku Kogyo Kabushiki Kaisha and the like.

In the rubber composition comprising the intermediate rubber layer, an alkene acrylic ester is preferably cross-linked to an EPDM having an iodine value of from about 6 to about 30 and an ethylene ratio of from about 48 to about 70 wt %; an iodine value of from about 10 to about 24 and an ethylene ratio of from about 50 to about 65 wt % is more preferable.

A monomer (a third component) of a diene group contained by this EPDM preferably has a carbon number of 5 to 20, and includes, for example, 1,4-pentadiene, 1, 4-hexadiene, 1,5-hexadiene, 2,5-dimethyl-1,5-hexadiene, 1,4-octadiene, 1, 4-cyclohexadiene, cyclooctadiene, dicyclopentadiene (DCP), 5-ethylidene-2-norbornene (ENB), 5-butylidene-2-norbornene, 2-methacryl-5-norbornene, 2-isopropenyl-5-norbornene and the like. Among these monomers (third components) of a diene group, dicyclopentadiene (DCP) or 5-ethylidene-2-norbornene (ENB) is preferable.

In the present invention, a compound of a resorcinol group is used preferably together with at least a rubber of an acryl group and/or an EPDM as described above. Namely, the use of a compound of a resorcinol group in combination with a specific rubber is preferable because it improves the adhesive properties without the necessity of adding an adhesive agent.

The selected resorcinol group is not critical and may include, for example, a modified resorcin-formaldehyde resin, resorcin, resorcin-formaldehyde (RF) resin and the like, which are used singly or in combination of two or more. Among these, a modified resorcin-formaldehyde resin is used suitably from the point of view of the vaporization property, hygroscopicity and compatibility with a rubber.

The modified resorcin-formaldehyde resin includes, for example, one which has the following formulae (III), (IV), and (V). Among these, general formula (III) is particularly preferable.

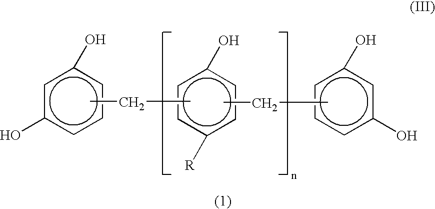

wherein R represents a hydrocarbon group and n represents a number of 0 to 3

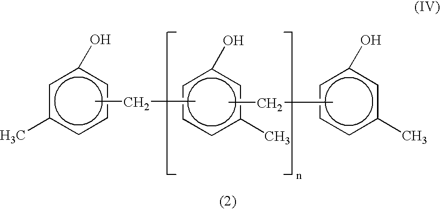

wherein R represents a hydrocarbon group and n represents a number of 0 to 3

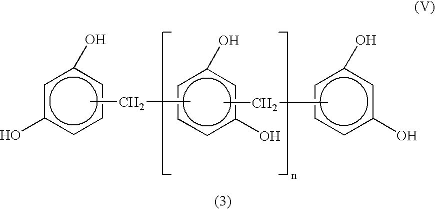

wherein R represents a hydrocarbon group and n represents a number of 0 to 3

The blend ratio of a compound of a resorcinol group is preferably 0.1 to 10 parts by weight (abbreviated as parts hereafter), more preferably 0.5 to 5 parts to 100 parts of the above specific rubber from the point of view of the adhesive properties and the like.

Any vulcanizing agent for a rubber of an acryl group and EPDM may be included, although a vulcanizing agent of a peroxide group is preferred.

The vulcanizing agent of a peroxide group includes, for example; 2, 4-dichlorobenzoylperoxide; benzoylperoxide; 1,1-di-t-butylperoxy-3, 3, 5-trimethylcyclohexane; 2,5-dimethyl-2,5-dibenzoylperoxyhexane; n-butyl-4, 4′-di-t-butylperoxyvalerate; dicumylperoxide; t-butylperoxybenzoate; di-t-butylperoxy-diisopropylbenzene; t-butylcumylperoxide; 2,5-dimethyl-2, 5-di(-t-butylperoxy)hexane; di-t-butylperoxide; 2,5-dimethyl-2, 5-di(-t-butylperoxy)hexyne-3 and the like, which are used singly or in combination of two or more. Among these, di-t-butylperoxy-diisopropylbenzene is preferred.

The blending ratio of a vulcanizing agent of a peroxide group is preferably 1.5 to 20 parts to 100 parts of the above specific rubber. Namely, less than 1.5 parts of the vulcanizing agent result in a low strength of a hose because of insufficient crosslinking. On the other hand, more than 20 parts of it tends to give a low flexibility of a hose because of over-hardness.

The intermediate rubber layer 2 may also include a reinforcing material, process oil, plasticizer, antioxidant, processing aid, vulcanization accelerator, accelerator activator, white filler, reactive monomer, blowing agent and the like which are to be used appropriately in combination with the specific rubber.

The reinforcing material may include, for example, carbon black, white carbon and the like.

The plasticizer includes, for example, a plasticizer of a phthalate group such as dioctyl phthalate (DOP), dibutyl phthalate (DBP) and the like; a plasticizer of an adipate group such as dibutylcarbitol adipate, dioctyl adipate (DOA) and the like; a plasticizer of a sebacate group such as dioctyl sebacate (DOS), dibutyl sebacate (DBS) and the like.

The antioxidant includes, for example, an antioxidant of a carbamate group (hereinafter “type”), antioxidant of a phenylenediamine type, antioxidant of a phenol type, antioxidant of a diphenylamine type, and antioxidant of a quinoline type, waxes and the like.

The processing aid includes, for example, stearic acids, ester of fatty acids, amides of fatty acids, hydrocarbon resins and the like.

The vulcanization accelerator includes, for example, an accelerator of a thiazole group; accelerator of a thiuram group; accelerator of a sulfenamide group such as N-cyclohexyl-2-benzothiazylsulfenamide (CBS), dibenzothiazyl disulfide (MBTS), 2-mercaptobenzothiazol (MBT), tetramethylthiuram monosulfide (TMTM) and the like.

The vulcanization accelerator activator includes, for example, zinc oxide, active zinc oxide, magnesium oxide and the like.

In the present invention, the intermediate rubber layer 2 is preferably covered by a reinforcing thread to form a reinforcing layer 3. The wire layer 3 may be composed of, for example, an aramid (aromatic polyamide) thread, nylon (polyamide) thread such as nylon 6, nylon 66 and the like, rayon thread, polyethylene terephthalate (PET) thread, wound as wire or as a braid to be used singly or in combination of two or more. Among these, an aramid thread and wire are used suitably because of their excellent thermal resistance.

The method of weaving the above reinforcing thread to form the reinforcing layer 3 is not critical to this invention and may include, for example, spiral weaving, plate weaving and the like.

The composition of the external layer 4 formed on the outer circumferential face of reinforcing layer 3 is not critical and may include, for example, EPDM, chloroprene rubber (CR), butyl rubber (IIR), halogenated butyl rubber (CI-IIR, Br-IIR), chlorinated polyethylene rubber (CPE), isoprene rubber (IR), urethane rubber, epichlorohydrin rubber (ECO), acrylic rubber and the like, which are used singly or in combination of two or more.

The external layer 4 may further include a processing aid, antioxidant, reinforcing material, process oil, plasticizer, vulcanizing agent, vulcanization accelerator, accelerator activator, retarder, and filler and the like.

The vulcanizing agents include, for example, a sulfur compound such as sulfur, morpholine, disulfide and the like; organic peroxide; ethylenethiourea; and the like.

The retarders include, for example, N-(cyclohexylthio) phthalimide and the like.

The fillers include, for example, calcium carbonate, magnesium carbonate, clay, talc and the like.

The flexible hose of FIG. 1 can be produced, for example, in the following manner. First, a metal bellows tube 1 is formed having the bellows structure described hereinabove; a mandrel is inserted into the inside of the metal bellows tube 1. Secondly, raw materials for intermediate rubber layer 2 which are flowable at low temperature is prepared by blending the specific rubber composition (rubber of an acryl group or EPDM), with a compound of a resorcinol group, vulcanizing agent of a peroxide group and the like. After the materials for intermediate rubber layer 2 are heated at about 100° C. to increase the flowability, an extrusion molding, press working or injection molding is carried out on the surface of the above metal bellows tube 1. A reinforcing thread is then spirally wound on the outer circumferential face of thus molded intermediate rubber layer 2 to form reinforcing layer 3. Next, an extrusion molding is carried out on the outer circumferential face of the reinforcing layer 3, using materials to form the external layer 4. After full vulcanization of the rubber by heating at about 160° C., the mandrel is pulled out to form a flexible hose which includes intermediate rubber layer 2 formed in the outer circumferential face of metal bellows tube 1, reinforcing layer 3 formed on the outer circumferential face of the layer 2 and external layer 4 formed on the outer circumferential face of the layer 3. In a manner described above, the channel 7 of the metal bellows tube 1 will be filled sufficiently with materials of intermediate rubber layer 2 as far down as valley 9.

The size of the flexible hose thus obtained is not limited to a special one, and its inside diameter is usually about 5 to 25 mm. Also, the thickness of each layer composing the hose is not limited to a special one as long as the desired function of each layer is accomplished sufficiently. For example, the thickness of intermediate rubber layer 2 is usually about 0.1 to 4 mm, and that of external layer 4 is usually about 0.8 to 4 mm. The thickness of intermediate rubber layer 2 is that from a pointed end of peak 6 of metal bellows tube 1 to reinforcing layer 3, and does not include the thickness of a rubber filling channel 7 between peaks 6.

The flexible hose of the present invention is not limited to that of the structure shown in FIG. 1. For example, another rubber layer can be also formed between intermediate rubber layer 2 and the external layer 4 or the external layer 4 can be omitted.

The flexible hose of the present invention can be used as a fuel hose in a car, an air hose, air conditioning hose, hose for a fuel cell powered vehicle (methanol fuel hose, hydrogen fuel hose) and the like because of its very excellent low permeability.

The invention is described further in the following examples, which are illustrative only and in no way limiting.

### EXAMPLE 1

Preparation of Materials for Intermediate Rubber Layer

One hundred parts of an ethylene-acrylic ester copolymer (VAMAC-G, manufactured by Du Pont; Viscosity (MV): 15/100° C.) having the above structural unit (a) within its molecular structure as a rubber of an acryl group; 1 part of stearic acid (Lunac S30, manufactured by Kao Corporation) as a processing aid; 0.5 part of a processing aid (Armeen18D, manufactured by Lion-Akuzo Co., Ltd.); 2 parts of a processing aid (Phosphanol RL210, manufactured by Toyo Chemical Co., Ltd.) 40 parts of carbon black (Seast SO, manufactured by Tokai Carbon Co., Ltd.); 1 part of a compound of a resorcinol group (Sumikanol 620, manufactured by Sumitomo Chemical Co., Ltd.); and 2 parts of an antioxidant (Nowguard 445, manufactured by Uniroyal K. K.) were mixed by a Banbary mixer. To this mixture, 0.77 part of a melamine resin (Sumikanol 507A, manufactured by Sumitomo Chemical Co., Ltd.); 4.2 parts of a vulcanizing agent of a peroxide group (Peroximon F-40, manufactured by NOF Corporation) and 1 part of a reactive polymer (TAIC, manufactured by Nippon Kasei Chemical) were added. The resulting mixture was mixed by a roll to give materials used for an intermediate rubber layer, which had the viscosity (MV) of 35 at 100° C.

Preparation of Materials for External Layer

One hundred parts of EPDM (Esprene 501A, manufactured by Sumitomo Chemical Co., Ltd.); 1 part of stearic acid (Lunac S30, manufactured by Kao Corporation) as a processing aid; 3 parts of zinc oxide (two kinds of zinc oxide, manufactured by Mitsui Metal Mining Co., Ltd.) as a vulcanization accelerating aid; 100 parts of carbon black (Seast SO manufactured by Tokai Carbon Co., Ltd.); and 60 parts of a process oil (Diana Process Oil PW-380, manufactured by Idemitsu Kosan Co., Ltd.) were mixed by a Banbary mixer. To this mixture, 0.75 part of tetramethylthiuram disulfide (Sancerar TT, manufactured by Sanshin Chemical Co., Ltd.) as a vulcanization accelerator; 0.75 part of zinc dimethyldithiocarbamate (Sancerar PZ, manufactured by Sanshin Chemical Co., Ltd.); 0.5 part of mercaptobenzothiazol (Sancerar M, manufactured by Sanshin Chemical Co. Ltd.); and 1.5 parts of sulfur as a vulcanizing agent were added. The resulting mixture was mixed by a roll to give material used for an external layer.

Manufacturing of Flexible Hose

First, a metal bellows tube having the bellows structure described above was formed, and a mandrel was inserted into the inside of the metal bellows tube. Secondly, the intermediate rubber layer, prepared as described above, was heated at 100° C. to increase flowability and an extrusion molding was carried out on the surface of the metal bellows tube, using the rubber composition. Then, a reinforcing thread (aramid thread) was wound on the outer circumferential face of the molded intermediate rubber layer to form a reinforcing layer. Next, an extrusion molding was carried out on the outer circumferential face of the reinforcing layer, using the above materials for an external layer. After full vulcanization of the rubber by heating at about 160° C. for 45 minutes, the mandrel was pulled out of the metal bellows tube to produce a flexible hose (with e.g. an inside diameter: 6 mm) which includes the intermediate rubber layer formed in the outer circumferential face of the metal bellows tube, the reinforcing layer formed on the outer circumferential face of the intermediate rubber layer and the external layer formed on the outer circumferential face of the reinforcing layer.

### EXAMPLE 2

Preparation of Materials for Intermediate Rubber Layer

One hundred parts of EPDM (Esprene 5754, manufactured by Sumitomo Chemical Co., Ltd.; Viscosity (MV): 30/100° C.); 1 part of the modified resorcin-formaldehyde resin with the above general formula (1) (Sumikanol 620, manufactured by Sumitomo Chemical Co., Ltd.) as a compound of a resorcinol group; 5 parts of an epoxy resin of bisphenol A type (Epikote 828, manufactured by Yuka-Shell Epoxy K. K.) as an epoxy resin; 100 parts of carbon black (Seast SO, manufactured by Tokai Carbon K. K.); and 60 parts of a process oil (Diana Process Oil PW-380, manufactured by Idemitsu Kosan Co. Ltd.) were mixed by a Banbary mixer. To this mixture, 4.2 parts of di-t-butylperoxy-diisopropylbenzene (Peroximon F-40, manufactured by NOF Corporation) as a vulcanizing agent of a peroxide group; 1 part of a reactive monomer (Hi-Cross ED-P, manufactured by Seiko Chemical Co., Ltd.); and 0.77 part of a methylated formaldehyde-melamine polymer (Sumikanol 507A, manufactured by Sumitomo Chemical Co., Ltd.) as a melamine resin were added. The resulting mixture was mixed by a roll to give materials used for an intermediate rubber layer, which had the viscosity (MV) of 38 at 100° C.

Manufacturing of Flexible Hose

A flexible hose was produced in a manner similar to that described in Embodiment 1, except the use of the above materials for an intermediate rubber layer.

Comparative Reference

For comparison in Table I, an intermediate rubber layer was used, composed of silicon rubber (SE1187U, manufactured by Toray-Dow-Corning Silicon) having a viscosity (MV) at 100° C. of 25. A flexible hose was otherwise produced in a manner similar to that described in Example 1, except for use of this silicon rubber.

An assessment of the property of the hose of the preferred embodiment relative to a reference hose having a silicon rubber intermediate layer 2 was carried out according to the following “Adhesion Property” and “Durability” standards. These results are shown in Table 1 below.

Adhesion Property

The multilayer structure including an intermediate rubber layer and reinforcing layer was cut out from each hose, which was mounted on a tensile testing machine (JIS B 7721). The adhesion strength (kg/25 mm) was measured by pulling the reinforcing layer side at the speed of 50 mm/min while fixing the rubber layer side. Also, separation of the reinforcing layer from the rubber layer was observed visually during the tensile test. Separation was assessed at O when the rubber layer was broken, and was assessed at X when the contact faces of the reinforcing layer and rubber layer were separated.

Durability

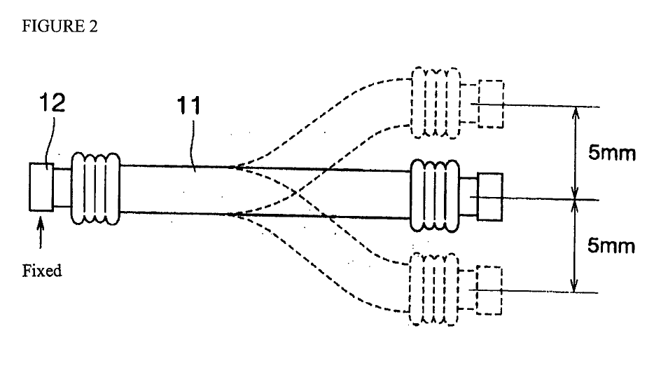

The assessment of durability of each hose was carried out by a whip test. Namely, as shown in FIG. 2, one end 12 of hose 11 with the test length (hose length) of 300 mm was fixed, and a whip test was carried out for 100 hours under the condition of a swing of ±5 mm, the pressure of 3.5 MPa and test temperature of 130° C. The durability was assessed at O when the test hose had no crack, and was assessed at X when the test hose had a crack.

TABLE 1

Embodiment

| | 1 | 2 | Reference hose |
|---|---|---|---|
| Adhesion strength | 2.8 | 2.5 | 0.1 |
| (kg/25 mm) | | | |
| Separation | ◯ | ◯ | X |
| Durability | ◯ | ◯ | X |

The above result shows that the hoses of the present invention have not only excellent adhesive properties between the intermediate rubber layer and the reinforcing layer but also excellent durability because of no shift exists between contact faces of the metal bellows tube and the intermediate rubber layer.

On the other hand, the Reference hose in Table 1 does not show satisfactory adhesive properties between the intermediate rubber layer and the reinforcing layer because of the poor adhesion strength of silicon rubber. Also, it is thought that, since silicon rubber has bad extrusion properties and low adhesion the metal bellows tube, a shift is caused between contact faces of both layers, resulting in low durability.

What is claimed is:

1. A flexible hose comprising: a metal bellows tube having a first rubber layer on the outer circumference thereof; and an exterior layer formed on the outer circumference of the first rubber layer; wherein the metal bellows tube has a corrugated structure with a plurality of spaced apart rings having peaks and a plurality of channels disposed between the rings forming valleys below the peaks and wherein the first rubber layer is of a composition including at least a rubber of an acryl group and/or a rubber of an ethylene-propylene-diene group and with the rubber layer being flowable at low temperature such that each channel is filled with rubber extending throughout each valley.

2. A flexible hose of claim 1, wherein the plurality of channels disposed between the rings vary in width in a radial direction wherein the width of each channel between peaks is narrower than the width of each valley below the peaks.

3. A flexible hose of claim 2, further comprising a reinforcing layer formed between said intermediate rubber layer and said exterior layer.

4. A flexible hose of claim 2, wherein said intermediate rubber layer further comprises a resorcinol group.

5. A flexible hose of claim 4 wherein the first rubber layer comprises an acryl group unit of the formula: 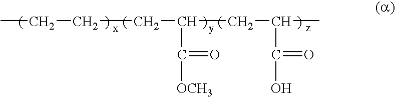
wherein, x=29.9˜74.9, y=25˜70, z=0.1˜18 and a carboxyl group is a crosslinking group.

6. A flexible hose of claim 4, wherein the first rubber layer comprises an acryl group unit of the formula: 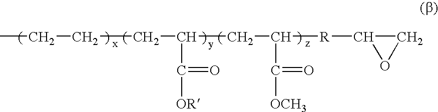
wherein, x=29.9˜74.9, y=25˜70, and z=0.1˜10, and further wherein R is hydrogen or ethyl group and R′ is alkyl group with carbon number 1˜18 and an end epoxy group is a crosslinking group.

7. A flexible hose of claim 5 wherein x=34.7˜69.7 and y=30˜65.
